(19) United States
(12) Patent Application Publication
(10) Pub. No.: US 2017/0295634 A1
(43) Pub. Date: Oct. 12, 2017

(54) HIGH VOLTAGE GENERATOR AND METHOD FOR SUPPLYING AN X-RAY TUBE

(71) Applicant: KONINKLIJKE PHILIPS N.V., EINDHOVEN (NL)

(72) Inventors: ALBERT GARCIA TORMO, EINDHOVEN (NL); PETER LUERKENS, EINDHOVEN (NL)

(21) Appl. No.: 15/507,485

(22) PCT Filed: Aug. 19, 2015
(86) PCT No.: PCT/EP2015/068979

§ 371 Date: Feb. 28, 2017

(30) Foreign Application Priority Data
Sep. 2, 2014 (EP) 14183194.1

(51) Int. Cl. H05G 1/12; H02M 7/5395; H05G 1/32; H05G 1/56; H05G 1/58

(52) U.S. Cl. CPC H05G 1/12; H05G 1/56; H05G 1/58; H05G 1/32; H02M 7/5395

(57) ABSTRACT

The present invention relates to a high voltage generator (100) for supplying an X-ray tube (200), the high voltage generator (100) comprising: a voltage regulator device (100-1), which is configured to provide a DC voltage; a plurality of N generator devices (100-2), which are coupled to the regulator device (100-1) and which comprise a switched-mode power circuit (100-2A) and which are configured to provide a waveform pattern (WP); and a plurality of N transformer devices (100-3), which are coupled to the generator device (100-2) and which are configured to provide a high voltage output pattern (HVOP) by means of the provided waveform pattern (WP) and further configured as a serial connection of the N transformer devices (100-3), whereby all provided high voltages HVOP are added, thereby yielding a higher voltage (THV) in the X-ray tube and wherein each of the plurality of the N generator devices (100-2) is configured to provide the waveform patterns (WP) adjusted to produce a substantially flat-pulse shaped pulse as the high voltage output pattern (HVOP) as an output of each of the N transformer devices (100-3) wherein the flat-pulse shaped pulse is achieved by means of double pulse/minimum time control.

### FIELD OF THE INVENTION

The present invention relates to the field of fast-dynamics high voltage generation. Particularly, the present invention relates to a high voltage generator and a method for supplying an X-ray tube.

### BACKGROUND OF THE INVENTION

X-rays in medical applications are supplied by high voltage generators. In order to minimize the X-ray dose and to increase the safety of the patient, the X-rays should only be supplied during the exposure. X-ray tubes generate radiation whenever they are supplied with high voltage with the cathode heated.

In certain applications a grid electrode is used in front of the cathode which cuts off the cathode current when a suitable control voltage is applied. The generation of this control voltage requires a substantial effort. Another option is to switch off and on the tube supply voltage.

The wavelength of the generated radiation depends upon the supply voltage. X-rays are typically generated when the tube is supplied between 60 kV and 140 kV. Nevertheless, supplying the tube with lower voltages also result in radiation. This radiation may be not part of the medical process or needed for the medical imaging but may also contribute to the X-ray dose, which the patient is exposed to.

US 2002/003408 A1 describes a pulsed high voltage power supply for use in a radiography system including a high voltage step up transformer having a primary winding with a first and second ends and a secondary winding connected to a radiation source. The power supply further includes a low voltage power source coupled to the first end of the primary winding and a switching circuit coupled to the second end of the primary winding.

US 2011/0235382 A1 describes a high voltage inverter device which receives as an input voltage a DC voltage, wherein the input voltage is switched by a switching element to pass an exciting current to excitation windings on a primary side of a plurality of separate transformers having same characteristics to simultaneously excite the excitation windings.

U.S. Pat. No. 6,900,557 B1 describes a compact transformer coupled modulator. The modulator includes a transformer comprising a primary and a plurality of secondary windings, where each secondary winding has an output terminal.

US 20010008552 A1 describes high-voltage transformer in an X-ray computer tomography apparatus, which performs the increase and noncontacting transmission of the power simultaneously and outputs a desired high voltage for causing X rays to be generated at the rotatable gantry section.

WO 2006/079985 A2 describes a power supply comprising a DC voltage supply, a control unit and a plurality of high voltage channels. Each high voltage channel includes an inverter, a resonance circuit, a transformer unit, and a rectifier.

US 20080187104 A1 describes an x-ray imaging apparatus which has the following features in configuration: a DC-AC converting part, a high-voltage transformer, an AC-DC converting part and an x-ray tube which are sealingly received within a housing part filled with oil.

US 20130163726 A1 describes X-ray equipment which is configured from a plurality of pressure rising units, a switching unit, and a switching control unit. The plurality of pressure rising units are connected to a battery unit and generate direct current voltage.

EP 0946082 A1 describes a portable x-ray system which comprises an x-ray source; an internal power supply for supplying an input voltage; and a voltage converter in electrical connection between the power supply and the source,

### SUMMARY OF THE INVENTION

There may be a need to improve high voltage generation for X-ray tubes.

These needs are met by the subject-matter of the independent claims of the present invention. Further exemplary embodiments of the present invention are evident from the dependent claims and the following description.

An aspect of the present invention relates to a high voltage generator for supplying an X-ray tube, the high voltage generator comprising: a voltage regulator device, which is configured to provide a DC voltage; a plurality of generator devices, which are coupled to the regulator device and which each comprise a switched-mode power circuit, for instance a full-bridge, and which each are configured to provide a waveform pattern using the provided DC voltage; and a plurality of N transformer devices, which are coupled to the generator device each of which is supplied by one of the N generator devices and which are configured to provide a high voltage output pattern by means of the provided waveform pattern and further configured as a serial connection of the N transformer devices, whereby all provided high voltages HVOP are added, thereby yielding a higher voltage (THV) in the X-ray tube and wherein each of the plurality of the N generator devices is configured to provide the waveform patterns (WP) adjusted to produce a substantially flat-pulse shaped pulse as the high voltage output pattern (HVOP) as an output of each of the N transformer devices wherein the flat-pulse shaped pulse is achieved by means of double pulse/minimum time control.

A further, second aspect of the present invention relates to a medical imaging system comprising a high voltage generator according to the first aspect or according to any implementation form of the first aspect and an X-ray tube.

A further, third aspect of the present invention relates to a method for supplying an X-ray tube, the method comprising the steps of providing a DC voltage by means of a voltage regulator device; providing a waveform pattern by means of a generator device using the provided DC voltage; and providing a high voltage output pattern by means of a transformer device using the provided waveform pattern.

The present invention provides means for a fast-dynamics high voltage generation.

The present invention advantageously provides a high voltage generator which is able to supply high voltage pulses with very fast transitions, which means that consequently, the X-ray tube can directly be connected to the high voltage generator without a grid switch.

The present invention advantageously provides a plurality of high voltage transformers and their respective power supplies or waveform generators.

The present invention advantageously uses a particular control technique to supply the X-ray tube with flat voltage for instance a minimum time or double pulse control. Depending on the supplied X-ray tube, a set of diodes, for instance high voltage diodes for high voltage/high current rectification tasks, may be necessary to prevent supplying the tube with negative voltages.

Minimum-time control or double pulse control achieves the fastest transitions by analysing the trajectories in the state space thus deriving appropriate pairs of control actions. Provided that the equivalent circuit modelling the plurality of transformers, generators and X-ray tube can be approximated by an LC resonant circuit, the trajectories in the state space are approximately ellipses (circumferences if using the proper scaling factor). In such a case, the trajectories in the state space are as depicted in FIG. 5. In the time domain, the voltage (solid line) and the current (dashed line) are as depicted in FIG. 6.

By using the proper pairs of control actions both the current and the voltage reach the required values at the same time thereby achieving flat pulses. For example, the first transition starts with both the current and the voltage at value 0 (centre in the state space of FIG. 5); when the first control action is applied, both the voltage and the current then start to decrease (become negative, counter-clockwise rotation in the state space); then a second control action is applied; during the second control action the voltage further decreases but the current increases. If the control actions were properly timed, both the voltage and the current will reach the targeted value at the same time (in this case, −60 kV and 0 A); then the steady control action can be applied. Provided that both the voltage and the current match the steady value, none of them changes its value anymore and hence a flat pulse is generated.

These pairs of control actions to achieve flat pulses in the transformer's secondary end are captured as pairs of pulses in the transformer's primary end. This is referred to as double pulse control. The entire sequence corresponding to the two FIGS. 5 and 6 is illustrated in FIG. 7.

It is possible to use more than two control actions per transition, in order to limit the value of some variables (e.g. current). Hence the term double pulse control may cover more than two control actions: e.g. additional pulses. It is also possible to use different voltage levels in the transitions

The waveform generators may be supplied from a DC power supply, typically a few hundreds of volts, for instance between 12 V and 1200 V.

The present invention provides a modular concept which can be implemented with only one transformer and one waveform generator or with multiple transformers and waveform generators wherein the multiplicity of transformers and waveform generators may be of different kind.

According to an exemplary embodiment of the present invention, the voltage regulator device comprises a high-voltage and high-power battery. The voltage regulator device may comprise a high-voltage and/or high-power battery to operate in non-reliable power grids or even off-grid partially supplying the X-ray tube from the battery. This advantageously allows a reliable and sufficient supply of the high voltage generator with electrical power.

According to a further exemplary embodiment of the present invention, the voltage regulator device is configured to provide a DC low voltage (compared to the output voltage), typically in the range on +/−12 V to +/−1200 V for common applications.

According to an exemplary embodiment of the present invention, the voltage regulator device comprises a half bridge circuit or a full bridge circuit or a boost converter circuit or a power converter circuit. A full bridge converter advantageously provides high output power and efficient designs and provides an increased power output.

According to the present invention, the high voltage generator comprises a plurality of N generator devices and N transformer devices, each of which is supplied by one of the N generator devices. This advantageously provides a modular approach for fabricating the high voltage generator. Similar circuits may be used to build the voltage generator.

According to an exemplary embodiment of the present invention, the high voltage generator comprises three generator devices and three transformer devices, each of which is supplied by one of the three generator devices. This advantageously provides a modular approach for fabricating the high voltage generator.

According to an exemplary embodiment of the present invention, each of the N transformer devices or each of the three transformer devices comprises a different maximum amplitude of the high voltage output pattern. This advantageously increases number of possible supply voltage levels for the X-ray tube.

According to an exemplary embodiment of the present invention, a first transformer device of the three transformer devices is configured to provide a waveform pattern with an amplitude of +/−60 kV, a second transformer device of the three transformer devices is configured to provide a waveform pattern with an amplitude of +/−30 kV, and a third transformer device of the three transformer devices is configured to provide a waveform pattern with an amplitude of +/−30 kV.

This advantageously provides means for adjusting the amplitude of the generated voltage according to varying needs and requirements.

According to an exemplary embodiment of the present invention, each of the transformer devices of the three transformer devices is configured to provide a waveform pattern with an amplitude of +/−40 kV. This advantageously provides means for adjusting the amplitude of the generated voltage according to varying needs and requirements.

According to the present invention, the generator device or each of the plurality of the N generator devices is configured to provide the waveform pattern adjusted to produce a substantially flat-pulse shaped pulse as the high voltage output pattern as an output of the transformer device or as an output of each of the N transformer devices.

According to the present invention, the generator device or each of the plurality of the N generator devices is configured to provide a double pulse/minimum time control.

According to a further exemplary embodiment of the present invention, the high voltage generator further comprises a reverse polarity guard diode, which is configured to provide protection against polarity reversal. This advantageously allows protecting the supplied X-ray rube.

A computer program performing the method of the present invention may be stored on a computer-readable medium.

A computer-readable medium may be a floppy disk, a hard disk, a CD, a DVD, an USB (Universal Serial Bus) storage device, a RAM (Random Access Memory), a ROM (Read Only Memory) and an EPROM (Erasable Programmable Read Only Memory). A computer-readable medium may also be a data communication network, for example the Internet, which allows downloading a program code.

The methods, systems and devices described herein may be implemented as software in a Digital Signal Processor, DSP, in a micro-controller or in any other side-processor or as hardware circuit within an application specific integrated circuit, ASIC.

The devices of the present invention can be implemented in digital electronic circuitry, or in computer hardware, firmware, software, or in combinations thereof, e.g. in available hardware of medical imaging devices or in hardware dedicated for processing the methods described herein.

### BRIEF DESCRIPTION OF THE DRAWINGS

A more complete appreciation of the present invention and the attendant advantages thereof will be more clearly understood by reference to the following schematic drawings, which are not to scale, wherein:

FIG. 1 shows a schematic diagram of a high voltage generator for supplying an X-ray tube according to an exemplary embodiment of the invention of the present invention;

FIG. 2 shows a schematic diagram of a high voltage generator for supplying an X-ray tube according to a further exemplary embodiment of the present invention;

FIG. 3 shows a schematic diagram of a medical imaging system according to a further exemplary embodiment of the present invention;

FIG. 4 shows a schematic diagram of a flow-chart diagram of a method for supplying an X-ray tube according to a further exemplary embodiment of the invention of the present invention;

FIG. 5 shows a state space diagram of voltage V versus current I at the transformer's secondary end;

FIG. 6 shows in the time domain the corresponding signal to the diagram of FIG. 5; and

FIG. 7 shows the corresponding signal in the time domain in the transformer's primary end.

### DETAILED DESCRIPTION OF EMBODIMENTS

The illustration in the drawings is purely schematic and does not intend to provide scaling relations or size information. In different drawings, similar or identical elements are provided with the same reference numerals. Generally, identical parts, units, entities or steps are provided with the same reference symbols in the description.

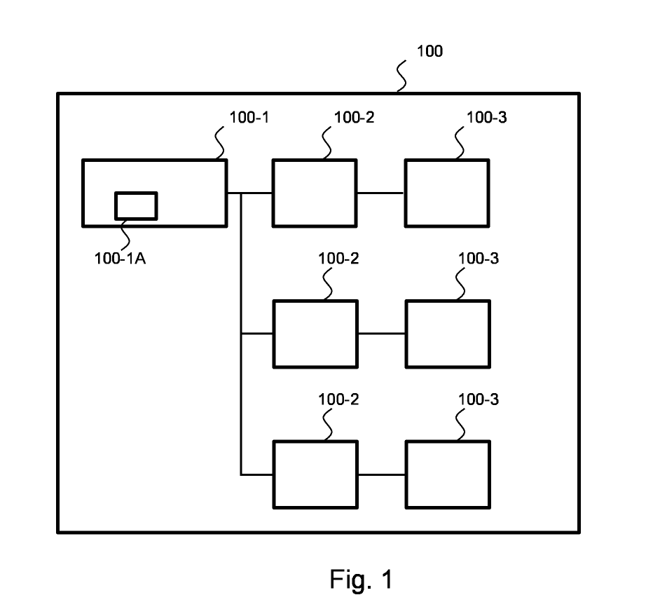

FIG. 1 shows a schematic diagram of a high voltage generator for supplying an X-ray tube according to an exemplary embodiment of the present invention.

A high voltage generator may comprise a voltage regulator device 100-1, a plurality of generator devices 100-2, and a plurality of transformer devices 100-3.

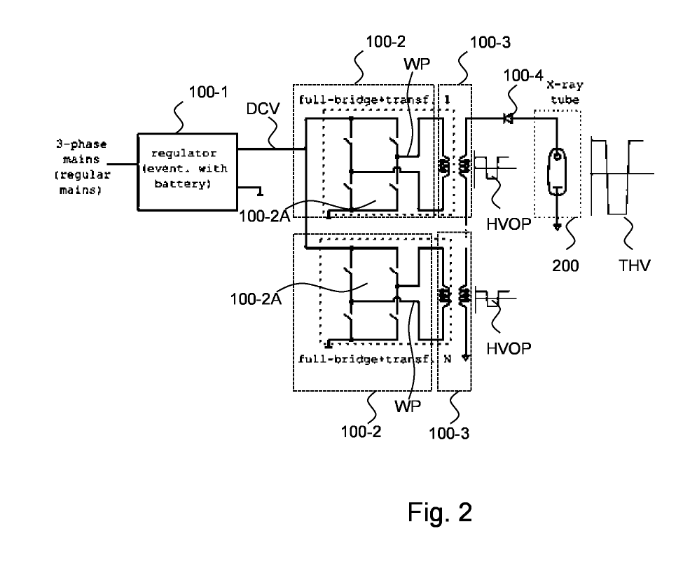

FIG. 2 shows a schematic diagram of a high voltage generator for supplying an X-ray tube according to a further exemplary embodiment of the present invention. The high voltage generator 100 may comprise only one generator device 100-2 and only one transformer device 100-3, a case which is not shown in FIG. 2 in which N generator devices 100-2 and N transformer devices 100-3 are shown, wherein N may refer to any natural number, for instance ranging from 2 to 30, or from 2 to 10, the number may be determined by the application of the voltage regulator device 100-1.

The voltage regulator device 100-1 may be configured to provide a DC voltage DCV. The generator device 100-2 may be coupled to the regulator device 100-1 and may comprise a bridge circuit 100-2A and may be configured to provide a waveform pattern WP using the provided DC voltage DCV.

The transformer device 100-3 may be coupled to the generator device 100-2 and may be configured to provide a high voltage output pattern HVOP by means of the provided waveform pattern WP.

As shown in FIG. 2, the present invention has a modular approach. It can be implemented with only one transformer and one waveform generator or with N transformers or N waveform generators which are not necessary identical. A reasonable choice of transformers and generators would be to use three transformers and three waveform generators. According to further embodiment of the present invention, one generator and one transformer may be used.

The high voltage generator may comprise the voltage regulator device 100-1 which supplies a constant DC voltage, typically around 400 V for silicon-MOSFET-based switches or around 1 kV for silicon carbide-based switches or SI-IGBTs. The voltage regulator device 100-1 may supply N full-bridge converters each of which supplies a transformer device 100-3. More than one 100-1 generator can also be used.

In the secondary side, these transformers 100-3 are all connected in series, as depicted in FIG. 2. One of the two remaining ends one is grounded and the other is connected to the X-ray tube 200, supplying the X-ray tube 200 with the high voltage THV, a summation of all in series connected transformers 100-3. The high voltage THV depends on the sum of provided high voltage output pattern HVOP.

Depending on the X-ray tube 200, a diode or a plurality of diodes 100-4 may be used to prevent supplying the tube with reverse polarity. The operation of the high voltage generator 100 is performed by proper control actions in the waveform generators of the generator device 100-2 for instance by double-pulse control.

With the proper pulse patterns in the primary, the voltage waveforms in all secondaries are substantially flat pulses with equal lengths, typically a pre-magnetization pulse, the exposure pulse and a demagnetization pulse.

According to an exemplary embodiment of the present invention, the length or duration of the substantially flat pulses of the pulse pattern, applying to the high voltage output patterns HVOP and to the high voltage THV, may be in the range of 10 to 10.000 μs.

The term “substantially flat pulses” as used by the present invention may refer to a variation of the voltage level of less than 10% or less than 5%.

Because of the serial connection of the transformer devices 100-3, all provided high voltages HVOP are added, thereby yielding a higher voltage in the X-ray tube, the high voltage THV.

The transformer devices 100-3 may have a high turn ratio, to boost the voltage from hundreds of volts to tens of kilovolts. Nevertheless, the turn ratio of the transformers does not need to be the same, and not all of them need to be always operated.

According to an exemplary embodiment of the present invention, X-rays of different energies can be generated, for instance if using three transformers they could provide any sum of their output voltages, for instance if the three high voltage output patterns HVOP have maximum amplitude of 60 kV, 30 kV and 30 kV, exposures of 60 kV, 90 kV and 120 kV as the high voltage THV are possible.

If the high voltage output patterns HVOP are set to three times 40 kV, exposure voltages of 80 kV and 120 kV as the high voltage THV are possible.

An arbitrary scaling of the indicated high voltage output patterns HVOP can be achieved by adjusting the output voltage of the voltage regulator device 100-1, e.g. the output voltage is maximum amplitude of the waveform pattern WP. By that pulsed exposures of any voltage level as the high voltage THV can be realized.

The high voltage generator 100 may be used for any X-ray-based applications such as single pictures, for instance radiographies or CV.

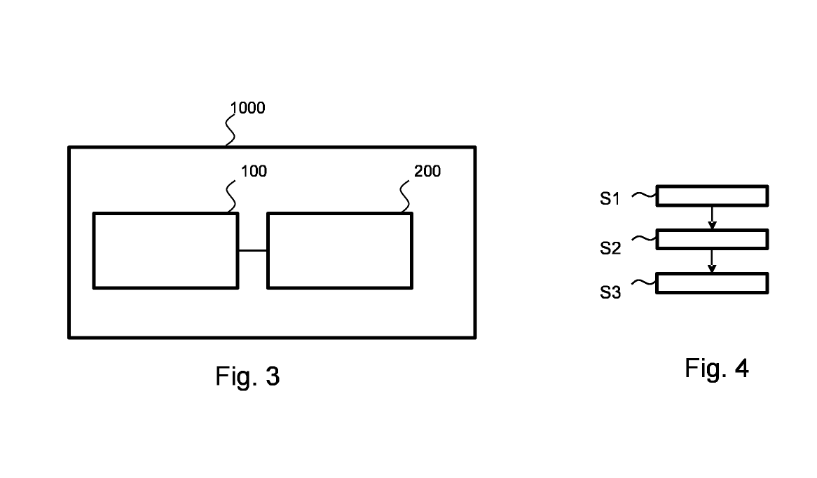

FIG. 3 shows a schematic diagram of a medical imaging system according to a further exemplary embodiment of the present invention.

A medical imaging system 1000 may comprise a high voltage generator 100 for supplying an X-ray tube 200. The medical imaging system 1000 may be an X-ray computed tomography system, a radiography system, a continuously scanning digital-radiography system, or any other kind of X-ray medical imaging system.

FIG. 4 shows an exemplary embodiment of a flow-chart diagram of a method for supplying an X-ray tube. The method may comprise the following steps. As a first step of the method, providing S1 a DC voltage DCV by means of a voltage regulator device 100-1 is performed.

As a second step of the method, providing S2 a waveform pattern WP by means of a generator device 100-2 using the provided DC voltage DCV may be performed.

As a third step of the method, providing S3 a high voltage output pattern HVOP by means of a transformer device 100-3 using the provided waveform pattern WP may be performed.

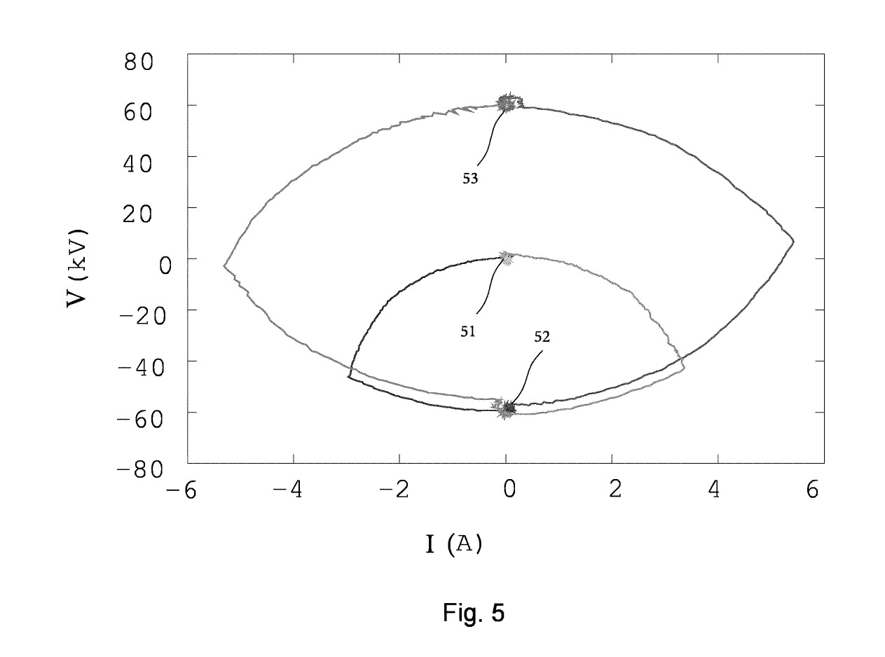

FIG. 5 shows a state space diagram of voltage V versus current I at the transformer's secondary end. Minimum-time control achieves the fastest transitions by analysing the trajectories in the state space thus deriving appropriate pairs of control actions. Provided that the equivalent circuit modelling the plurality of transformers, generators and X-ray tube can be approximated by an LC resonant circuit, the trajectories in the state space are approximately ellipses (circumferences if using the proper scaling factor). In such a case, the trajectories in the state space are as depicted in FIG. 5. By using the proper pairs of control actions both the current and the voltage reach the required values at the same time thereby achieving flat pulses.

For example, the first transition starts with both the current and the voltage at value 0 indicated by reference numeral 51 in the centre in the state space of FIG. 5; when the first control action is applied, both the voltage and the current then start to decrease (become negative, counter-clockwise rotation in the state space); then a second control action is applied; during the second control action the voltage further decreases but the current increases. If the control actions were properly timed, both the voltage and the current will reach the targeted value indicated by reference numeral 52 at the same time (in this case, −60 kV and 0 A); then the steady control action can be applied. Provided that both the voltage and the current match the steady value, none of them changes its value anymore and hence a flat pulse is generated. Then a third control action is applied same and both the voltage and the current start to increase until a fourth control action is applied; during the fourth control action the voltage further increases but the current decreases. If the control actions were properly timed, both the voltage and the current will reach the targeted value indicated by reference numeral 53 at the same time (in this case, +60 kV and 0 A); then the steady control action can be applied. Provided that both the voltage and the current match the steady value, none of them changes its value anymore and hence a flat pulse is generated.

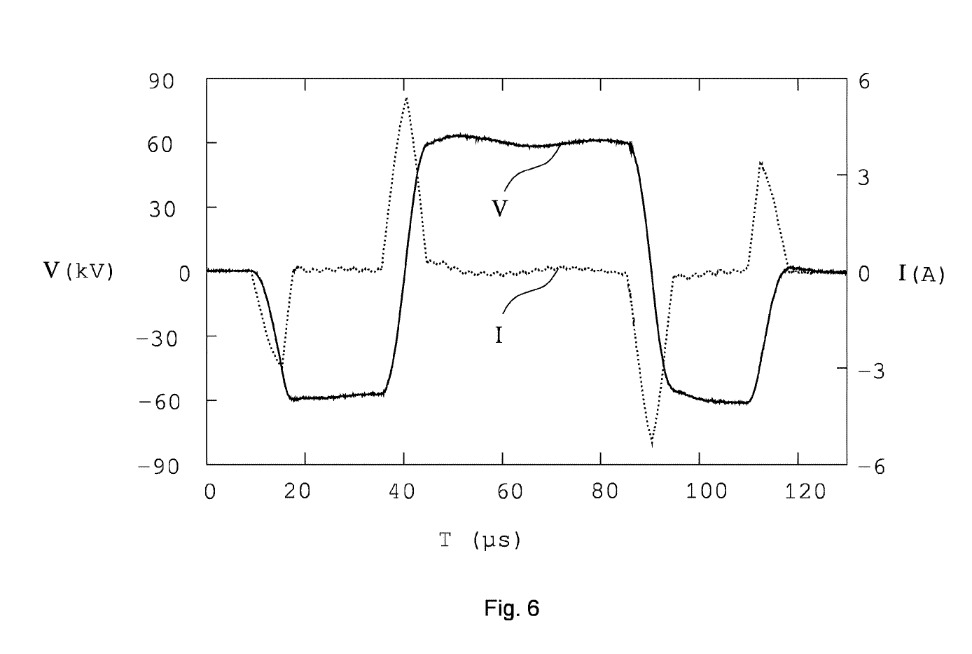

FIG. 6 shows the corresponding signal to the diagram of FIG. 5 in the time domain, the voltage V is represented as a solid line and the current I as a dashed line.

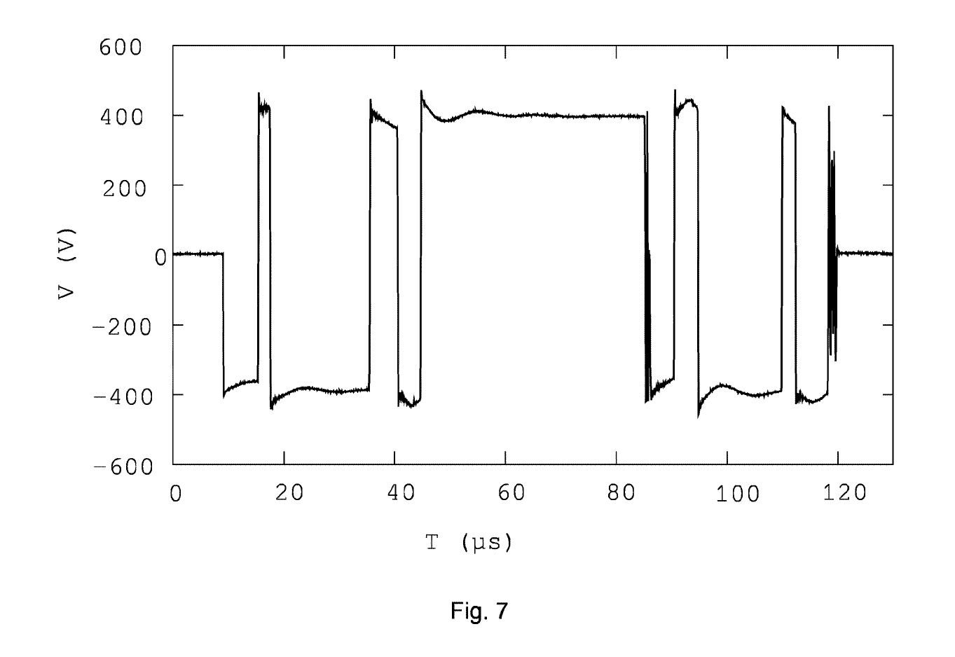

FIG. 7 shows the entire sequence corresponding to the two FIGS. 5 and 6 wherein pairs of pulses in the transformer's primary end result in pairs of control actions to achieve flat pulses in the transformer's secondary end. This is referred to as double pulse control/minimum time control.

It has to be noted that embodiments of the present invention are described with reference to different subject-matters. In particular, some embodiments are described with reference to method type claims, whereas other embodiments are described with reference to the device type claims.

However, a person skilled in the art will gather from the above and the foregoing description that, unless otherwise notified, in addition to any combination of features belonging to one type of the subject-matter also any combination between features relating to different subject-matters is considered to be disclosed within this application.

However, all features can be combined providing synergetic effects that are more than the simple summation of these features.

While the present invention has been illustrated and described in detail in the drawings and the foregoing description, such illustration and description are to be considered illustrative or exemplary and not restrictive; the present invention is not limited to the disclosed embodiments.

Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. Any reference signs in the claims should not be construed as limiting the scope.

1. High voltage generator for supplying an X-ray tube, the high voltage generator comprising:
a voltage regulator device, which is configured to provide a DC voltage;
a plurality of N generator devices, which are coupled to the regulator device and which each comprise a switched-mode power circuit and which each are configured to provide a waveform pattern using the provided DC voltage;
a plurality of N transformer devices, which are coupled to the generator devices each of which is supplied by one of the N generator devices and which are configured to provide a high voltage output pattern by means of the provided waveform pattern; and further configured as a serial connection of the N transformer devices, whereby all provided high voltage output patterns are added, thereby yielding a higher voltage in the X-ray tube; and wherein each of the plurality of the N generator devices is configured to provide the waveform patterns adjusted to produce a substantially flat-pulse shaped pulse as the high voltage output pattern as an output of each of the N transformer devices wherein the flat-pulse shaped pulse is achieved by means of double pulse/minimum time control.

2. The high voltage generator according to claim 1, wherein the voltage regulator device comprises a high voltage battery.

3. The high voltage generator according to claim 1, wherein the voltage regulator device is configured to provide a DC voltage in the range between +/−12 V and +/−1200 V as the DC voltage.

4. The high voltage generator according to claim 1, wherein the voltage regulator device comprises a half bridge circuit or a full bridge circuit or a boost converter circuit or a power converter circuit.

5. The high voltage generator according to claim 4, wherein the high voltage generator comprises three generator devices and three transformer devices, each of which is supplied by one of the three generator devices.

6. The high voltage generator according to claim 5 wherein each of the N transformer devices or each of the three transformer devices comprises a different maximum amplitude of the high voltage output pattern.

7. The high voltage generator according to claim 5, wherein a first transformer device of the three transformer devices is configured to provide a waveform pattern with an amplitude of +/−60 kV, a second transformer device of the three transformer devices is configured to provide a waveform pattern with an amplitude of +/−30 kV, and a third transformer device of the three transformer devices is configured to provide a high voltage output pattern with an amplitude of +/−30 kV.

8. The high voltage generator according to claim 5, wherein each of the transformer device of the three transformer devices is configured to provide a high voltage output pattern with an amplitude of +/−40 kV.

9. The high voltage generator according to claim 1, wherein the high voltage generator further comprises a reverse polarity guard diode, which is configured to provide protection against polarity reversal.

10. A medical imaging system comprising a high voltage generator according to claim 1 and an X-ray tube.

11. A method for supplying an X-ray tube, the method comprising the steps of:
providing (S1) a DC voltage by means of a voltage regulator device;
providing (S2) a plurality of waveform patterns by means of a plurality of N generator devices using the provided DC voltage; and
providing (S3) a high voltage output pattern by means of a plurality of transformer devices, each of which is supplied by one of the N generator devices using the provided waveform patterns wherein the N transformer devices are configured as a serial connection of the N transformer devices, whereby all provided high voltages output patterns are added, thereby yielding a higher voltage in the X-ray tube; and wherein each of the plurality of the N generator devices provides the waveform pattern adjusted to produce a substantially flat-pulse shaped pulse as the high voltage output pattern as an output of each of the N transformer devices wherein the flat-pulse shaped pulse is achieved by means of double pulse/minimum time control
